(19) United States
(12) Patent Application Publication
(10) Pub. No.: US 2008/0024488 A1
(43) Pub. Date: Jan. 31, 2008

(54) Real Time Stereoscopic Imaging Apparatus and Method

(75) Inventors: Hugo Mathieu Visser, Eindhoven (NL); Maarten Ter Mors, Eindhoven (NL); Karl Thiele, Andover, MI (US)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., EINDHOVEN (NL)

(21) Appl. No.: 11/577,373

(22) PCT Filed: Oct. 18, 2005
(86) PCT No.: PCT/IB05/53413

§ 371 Date: Apr. 17, 2007

Related U.S. Application Data
(60) Provisional application No. 60/621,197, filed on Oct. 22, 2004.

(51) Int. Cl. G06T 17/00

(52) U.S. Cl. 345/420

(57) ABSTRACT

The present invention relates to a stereoscopic imaging apparatus (2). The apparatus (2) comprises a real time ultrasound imaging device (14, 20, 22) for generating a real time 3D model of a patient's heart (4), combining the real time 3D model with a static 3D model of the region surrounding the heart (4) previously stored in memory (24), and generating stereoscopic image data of the combined real time and static 3D model. The apparatus also comprises a display (30) for simultaneously displaying the real time stereoscopic image of the heart (4) and a static stereoscopic image of the region surrounding the heart (4). By enabling a real time stereoscopic image of the heart (4) and a static stereoscopic image of the region surrounding the heart to be simultaneously displayed on the display (30), this improves the user's depth perception in viewing the real time image.

### FIELD OF THE INVENTION

The present invention relates to a real time stereoscopic imaging apparatus and method. The invention relates particularly, but not exclusively, to an apparatus and method for forming and displaying real time stereoscopic ultrasound images for use in medical applications.

### BACKGROUND OF THE INVENTION

The use of stereoscopic image displays in medical applications, in which slightly different images are provided to a user's left and right eyes in order to cause the user to see a three dimensional (3D) image, is known. A number of imaging techniques, such as x-ray or magnetic resonance imaging, are known in which high resolution static three-dimensional images can be generated.

It is also known to provide real time three-dimensional (3D) ultrasound images, for example for use in guiding a surgeon during heart surgery. An arrangement of this type is disclosed in U.S. Pat. No. 5,488,952.

However, real time 3D imaging apparatus suffers from the drawback that because many users require an interval of up to a second in order to adjust sufficiently to the 3D image to see the desired effect, the user's depth perception can be lost as a result of the rapid variation of the 3D image.

### SUMMARY OF THE INVENTION

Preferred embodiments of the present invention seek to provide a real time stereoscopic imaging apparatus and method in which the user's depth perception is improved compared with prior art systems.

According to an aspect of the present invention, there is provided a stereoscopic imaging apparatus comprising:
imaging means for receiving image data from a first region of an object;
first data processing means for forming real time three dimensional (3D) model data of said first region and combining said real time 3D model data with static 3D model data of a second region of said object, adjacent to said first region;
second data processing means for processing said combined real time 3D model data and static 3D model data to generate stereoscopic image data of said first and second regions, wherein said stereoscopic image data represents a plurality of views of said first and second regions from different directions; and
display means adapted to receive said stereoscopic image data to simultaneously display a real time stereoscopic image of said first region and a static stereoscopic image of said second region.

By simultaneously displaying a real time stereoscopic image of the first region and a static stereoscopic image of the second region, this provides the surprising advantage of improving the user's perceived depth by enabling the user to view a real time stereoscopic image of one part of an object together with a static stereoscopic image data of an adjacent part of the object. For example, the real time stereoscopic image may represent a patient's heart, and the static image may be of the patient's chest cavity surrounding the heart, thus improving a surgeon's depth perception during cardiac surgery.

The imaging means may be adapted to generate image data from said first region by means of ultrasound.

The apparatus may further comprise memory means for storing said real time 3D model data and/or said static 3D model data.

The imaging means may be further adapted to receive image data from said second region

The imaging means may be adapted to generate image data from said second region by means of X-rays.

The imaging means may be adapted to generate image data from said second region by means of computer tomography.

The imaging means may be adapted to generate image data from said second region by means of magnetic resonance imaging.

The first data processing means may be adapted to combine said real time 3D model data and said static 3D model data by comparing static and real time 3D model data of at least part of said second region.

According to another aspect of the present invention, there is provided a stereoscopic imaging method comprising:
receiving image data from a first region of an object;
forming real time 3D model data of said first region;
combining said real time 3D model data with static 3D model data of a second region of said object, adjacent said first region;
processing said combined real time 3D model data and static 3D model data to generate stereoscopic image data of said first and second regions, wherein said stereoscopic image data represents a plurality of views of said first and second region from different directions; and
inputting said stereoscopic image data to display means to simultaneously display a real time stereoscopic image of said first region and a static stereoscopic image of said second region.

The method may further comprise the step of generating image data from said first region by means of ultrasound.

The method may further comprise storing said real time 3D model data and/or said static 3D model data in memory means.

The method may further comprise the step of receiving image data from said second region.

The method may further comprise the step of generating image data from said second region by means of X-rays.

The method may further comprise the step of generating image data from said second region by means of computer tomography.

The method may further comprise the step of generating image data from said second region by means of magnetic resonance imaging.

The step of combining said real time 3D model data and said static 3D model data may comprise comparing static and real time 3D model data of at least part of said second region.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a schematic diagram of a real time ultrasound stereoscopic imaging apparatus embodying the present invention.

### DETAILED DESCRIPTION OF THE INVENTION

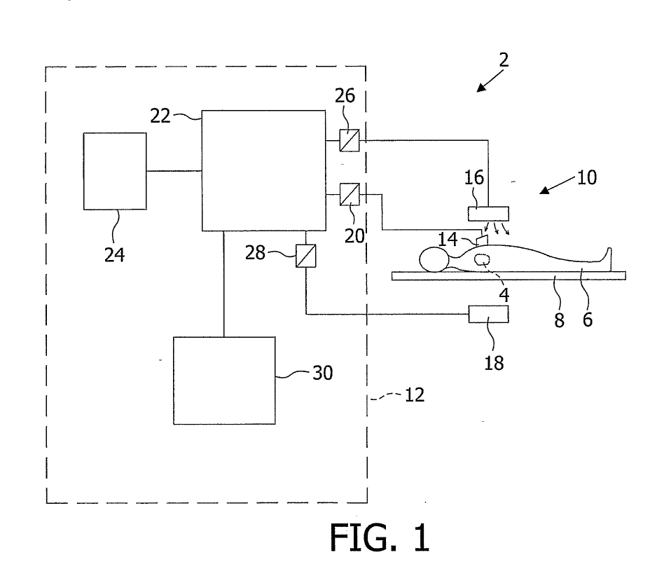

Referring to FIG. 1, a real time 3D ultrasound stereoscopic imaging apparatus 2 for producing real time stereoscopic images of a heart 4 of a patient 6 on a support 8 comprises an image data generating section 10 and a computer 12. The image data generating section 10 includes an ultrasonic transducer 14 for directing ultrasound into the patient 6 and receiving reflected ultrasound from the patient's internal organs such as the heart 4, and also includes an x-ray source 16 aligned with an x-ray detector 18, the purpose of which will be described in greater detail below.

The ultrasonic transducer 14 has a transmit mode in which ultrasound is directed into the patient 6, and a receive mode in which ultrasound reflected from the patient's internal organs is received and converted into image data in the form of electrical signals which are input via analogue to digital converter 20 to a processor 22 of computer 12, as will be familiar to persons skilled in the art. By means of suitable imaging software, the processor 22 generates a real time three dimensional (3D) model of the patient's heart 4.

The processor 22 is connected to a memory 24 which stores a static three-dimensional (3D) model of the patient's chest cavity in the region surrounding the patient's heart 4. This data can be acquired via a number of different methods, for example by means of the aligned x-ray transmitter 16 and detector 18, which are movable on a support (not shown) relative to the patient 6, but it will be appreciated by persons skilled in the art that acquisition of image data of the region surrounding the patient's heart 4 and subsequent formation of static 3D model data of the region surrounding the heart 4 will generally occur prior to imaging by means of the ultrasonic transducer 14, and may be carried out at a different location from the location of the ultrasound imaging.

Energisation of the x-ray source 16 is controlled by the processor 22 via a digital to analogue converter 26, and static image data in the form of electrical signals output by the x-ray detector 18 are input to the processor 22 via analogue to digital converter 2. The processor then generates static 3D model data of the region surrounding the patient's heart 4 and stores this static 3D model data in memory 24.

The processor scales the real time 3D model data and static 3D model data, for example by comparing the dimensions of parts of the real time 3D model data and the static 3D model data which adjoin or overlap each other.

The processor 22 then processes the combined real time and static 3D model data to generate stereoscopic image data representing views of the combined heart 4 and surrounding chest region from two or more chosen directions, at least two of which correspond to a user's left and right eyes, respectively. The stereoscopic image data is then input by processor 22 to a stereoscopic display 30 of the computer 12. The stereoscopic display may be any one of a number of suitable types of display for providing different images to the user's left and right eyes to enable a stereoscopic 3D image to be viewed, as will be familiar to persons skilled in the art.

In this way, the user views a real time stereoscopic 3D image of the patient's heart 4, together with a static stereoscopic 3D image of the chest region surrounding the heart 4.

The operation of the apparatus 2 shown in FIG. 1 will now be described.

The static image data of the region surrounding the patient's heart 4 is first gathered by scanning the patient by means of the movable x-ray source 16 and detector 18 pair. The data from the x-ray source 16 and detector 18 pair is processed by the processor 22 to generate a static 3D model of the region surrounding the patient's heart 4, and this static 3D model data is input to the memory 24. However, the 3D model of the region surrounding the patient's heart may consist of data generated on a previous occasion and stored in memory 24. For example, it will be appreciated by persons skilled in the art that this data may be obtained at a different location from that at which 3D ultrasound imaging takes place, in which case the x-ray source 16 and x-ray detector 18 can be omitted from the apparatus 2.

The real time image data of the heart 4 is then obtained by first placing the ultrasonic transducer 14 against the patient's chest and causing it to emit ultrasound in the transmit mode. The transducer 14 is then switched to the receive mode and signals corresponding to the received reflected ultrasound are input to the processor 22. The processor 22 then processes the signals to provide a real time 3D model of the heart 4, and combines this real time 3D model with the static 3D model of the region surrounding the heart 4 stored in memory 24. The processor 22 then processes the combined real time and static 3D model data to generate stereoscopic image data of the combined object consisting of the heart 4 and the surrounding chest region. The real time stereoscopic image of the heart 4 and the static stereoscopic image of the surrounding chest region are then simultaneously displayed on the display 30.

It is found that as a result of displaying the real time image of the heart 4 together with the static image of the surrounding region, the user's depth perception in viewing the real time video image is significantly improved compared with prior art systems. This offers several significant advantages, for example in guiding surgeons during interventions such as heart surgery.

It will be appreciated by persons skilled in the art that the above embodiment has been described by way of example only, and not in any limitative sense, and that various alterations and modifications are possible without departure from the scope of the invention as defined by the appended claims.

1. A stereoscopic imaging apparatus comprising:
imaging means for receiving image data from a first region of an object;
first data processing means for forming real time three dimensional (3D) model data of said first region and combining said real time 3D model data with static 3D model data of a second region of said object, adjacent to said first region;
second data processing means for processing said combined real time 3D model data and static 3D model data to generate stereoscopic image data of said first and second regions, wherein said stereoscopic image data represents a plurality of views of said first and second regions from different directions; and
display means adapted to receive said stereoscopic image data to simultaneously display a real time stereoscopic image of said first region and a static stereoscopic image of said second region.

2. An apparatus according to claim 1, wherein the imaging means is adapted to generate image data from said first region by means of ultrasound.

3. An apparatus according to claim 1, further comprising memory means for storing said real time 3D model data and/or said static 3D model data.

4. An apparatus according to claim 1, wherein the imaging means is further adapted to receive image data from said second region.

5. An apparatus according to claim 1, wherein the imaging means is adapted to generate image data from said second region by means of X-rays.

6. An apparatus according to claim 1, wherein the imaging means is adapted to generate image data from said second region by means of computer tomography.

7. An apparatus according to claim 1, wherein the imaging means is adapted to generate image data from said second region by means of magnetic resonance imaging.

8. An apparatus according to claim 1, wherein the first data processing means is adapted to combine said real time 3D model data and said static 3D model data by comparing static and real time 3D model data of at least part of said second region.

9. A stereoscopic imaging method comprising:
receiving image data from a first region of an object;
forming real time 3D model data of said first region;
combining said real time 3D model data with static 3D model data of a second region of said object, adjacent said first region;
processing said combined real time 3D model data and static 3D model data to generate stereoscopic image data of said first and second regions, wherein said stereoscopic image data represents a plurality of views of said first and second region from different directions; and
inputting said stereoscopic image data to display means to simultaneously display a real time stereoscopic image of said first region and a static stereoscopic image of said second region.

10. A method according to claim 9, further comprising the step of generating image data from said first region by means of ultrasound.

11. A method according to claim 9, further comprising storing said real time 3D model data and said static 3D model data in memory means.

12. A method according to claim 9, further comprising the step of receiving image data from said second region.

13. A method according to claim 9, further comprising the step of generating image data from said second region by means of X-rays.

14. A method according to claim 9, further comprising the step of generating image data from said second region by means of computer tomography.

15. A method according to claim 9, further comprising the step of generating image data from said second region by means of magnetic resonance imaging.

16. A method according to claim 9, wherein the step of combining said real time 3D model data and said static 3D model data comprises comparing static and real time 3D model data of at least part of said second region.
